(19) United States
(12) Patent Application Publication
(10) Pub. No.: US 2001/0051899 A1
(43) Pub. Date: Dec. 13, 2001

(54) Document managing apparatus for managing transaction slip data in electronic commerce

(76) Inventors: Takahiko Kawashima, Kawasaki (JP); Isamu Kawamura, Kawasaki (JP); Hideyuki Amaku, Kobe (JP)

Correspondence Address: STAAS & HALSEY LLP, 700 11TH STREET, NW, SUITE 500, WASHINGTON, DC, 20001, US

(21) Appl. No.: 09/760,878

(22) Filed: Jan. 17, 2001

(30) Foreign Application Priority Data
Jun. 13, 2000 (JP) 2000-176233

(51) Int. Cl. G06F 17/60

(52) U.S. Cl. 705/26

(57) ABSTRACT

A database managing module that is an order issuer server device or an order acceptor server device separately manages content data and management data of transaction slip data. Content data is a main text of a slip. Management data is extracted from the content data and used for searching the content data. Content data and management data are correlated with a document identifier uniquely assigned to the content data. When content data that is sent to a particular company is extracted from a large amount of content data, it is searched for management data with a key of the company name. Relevant content data is extracted corresponding to a document identifier of the extracted management data. The content data is transferred to the company.

### BACKGROUND OF THE INVENTION

1. Field of the Invention

The present invention relates to a document managing apparatus for managing transaction slip data in electronic commerce.

2. Description of the Related Art

As the Internet has become common, transactions are being aggressively carried out on the network. When transactions are carried out on the network, electronic data such as transaction slip data should be managed and used. In particular, since many transaction parties are connected to the network, the amount of transaction slip data becomes huge. In addition, when companies as transaction parties use different transaction slip data formats, the data formats should be converted. The transactions carried out on the network are referred to as electronic commerce. In the electronic commerce, a technology called EDI (Electronic Data Interchange) is becoming important.

As a standard technology for solving compatibility and convenience of electronic data in the open environment, it is expected to use XML data in the electronic commerce. When a large amount of XML data is stored, it is necessary to select an adequate data structure for an electronic data exchanging process (such as data reception, data transmission, data manipulation (for example, format conversion, data compression, data decompression, and data division), and data shuffling) and to designate the selected data structure as a search condition.

As a conventional technique for storing XML data to a database, an XML document is stored as a file to the database.

In the electronic data exchanging process for inter-company electronic commerce, transaction slips are generally processed corresponding to a particular information field such as a slip category, each slip acceptor, or each slip issuer. Thus, the searching efficiency of a particular field of transaction slip data should be improved.

FIG. 1 shows a schematic diagram for explaining a problem of the conventional electronic commerce.

In an inter-company electronic commerce system using a database device that directly stores an XML document as a file, transaction slip data is stored in its data structure. Thus, when the amount of transaction slip data becomes huge as in a large inter-company electronic commerce system, transaction slip data cannot be searched in a desired time period of the electronic data exchanging process.

In the electronic data exchanging process of the inter-company electronic commerce, transaction slip data for a particular order acceptor may be extracted from seder data of many order issuers and converted into the format of the particular order acceptor. For example, transaction slip data may be searched with a search key of particular data that identifies an order acceptor described in transaction slip data. In other words, transaction slip data is generally searched for a particular element thereof.

However, conventionally, all transaction slip data stored in an order issuer server is searched for transaction slip data for companies P, Q, and R as order issuers. The extracted transaction slip data is transmitted to the order acceptor server. In the order acceptor server, for example, order slip data for the company P as a search object is extracted from all the received transaction slip data. The extracted data is transferred to the company P.

Transaction slip data used in the intercompany electronic commerce is generally composed of a header portion and a record portion. The header portion contains parameters necessary for an electronic data exchanging process. The record portion contains detail data as the content of an order. In the electronic data exchanging process performed in an order issuer server and an order acceptor server, it is necessary to reference only the parameters for the electronic data exchanging process.

FIG. 2 is a schematic diagram showing an example of transaction slip data described as an XML document.

A data storing portion of an XML document is referred to as XML instance. The XML instance is a tagged text as shown in FIG. 1.

When an XML document containing such an XML instance is searched for data of a particular tag as a search condition, the efficiency of the searching process depends on the amount of data surrounded by tags of the XML document. For example, in the electronic data exchanging process, when an XML document containing an XML instance is searched for data of “an order acceptor code”, if all the XML file is searched, data surrounded by <record> and </record> tags is also searched. Occasionally, a portion surrounded by the <record> and </record> tags may contain a large amount of detail data.

Thus, in the inter-company electronic commerce using an XML document as transaction slip data, it is necessary to speed up the searching process using a search key of particular element data such as parameters necessary for the electronic data exchanging process.

### SUMMARY OF THE INVENTION

An object of the present invention is to provide a document management system that allows transaction slip data to be effectively managed in electronic commerce.

The present invention is a managing apparatus for managing a transaction slip data document used in electronic commerce with a database device, comprising a data extracting means for extracting data as a search item of the transaction slip data document therefrom, a storing means for storing the data extracted by the data extracting means as management data in correlation with the transaction slip data, a transaction slip data extracting means for searching the management data so as to extract correlated transaction slip data, and a transmitting means for transmitting the transaction slip data extracted by the transaction slip data extracting means.

According to the present invention, transaction slip data that is transmitted from many order issuers to order acceptors can be searched for individual order acceptors at high speed. In addition, in the process for transaction slip data, a trouble due to an insufficient process performance of the managing apparatus can be prevented.

These and other objects, features and advantages of the present invention will become more apparent in light of the following detailed description of a best mode embodiment thereof, as illustrated in the accompanying drawings.

### BRIEF DESCRIPTION OF DRAWINGS

FIG. 1 is a schematic diagram for explaining a problem of conventional electronic commerce;

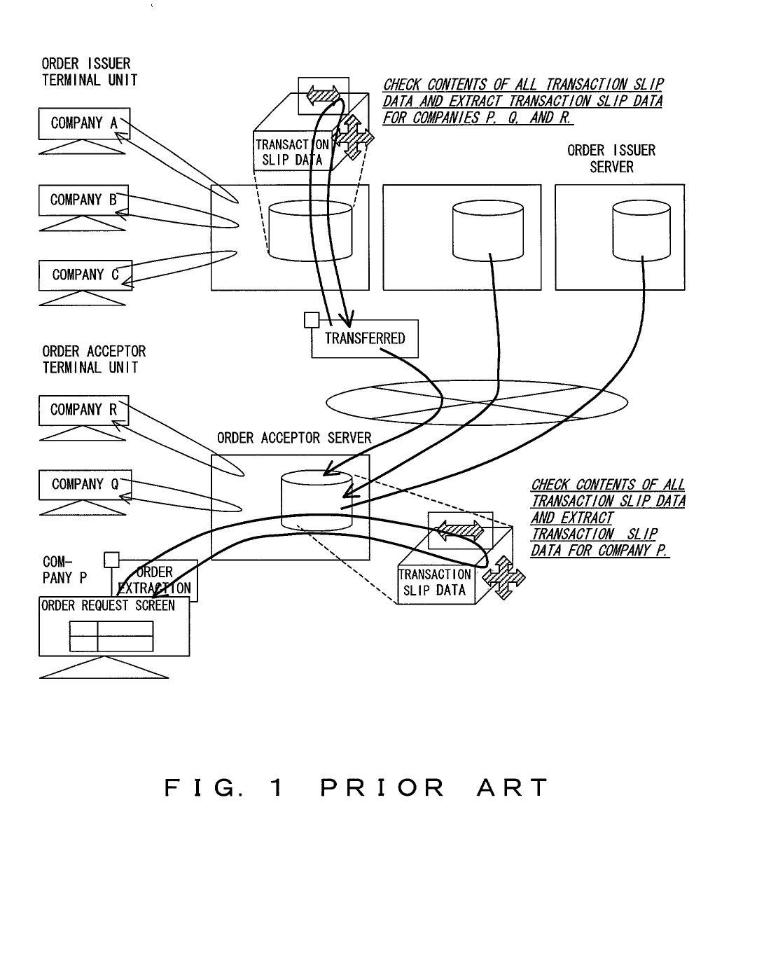

FIG. 2 is a schematic diagram showing an example of transaction slip data described as an XML document;

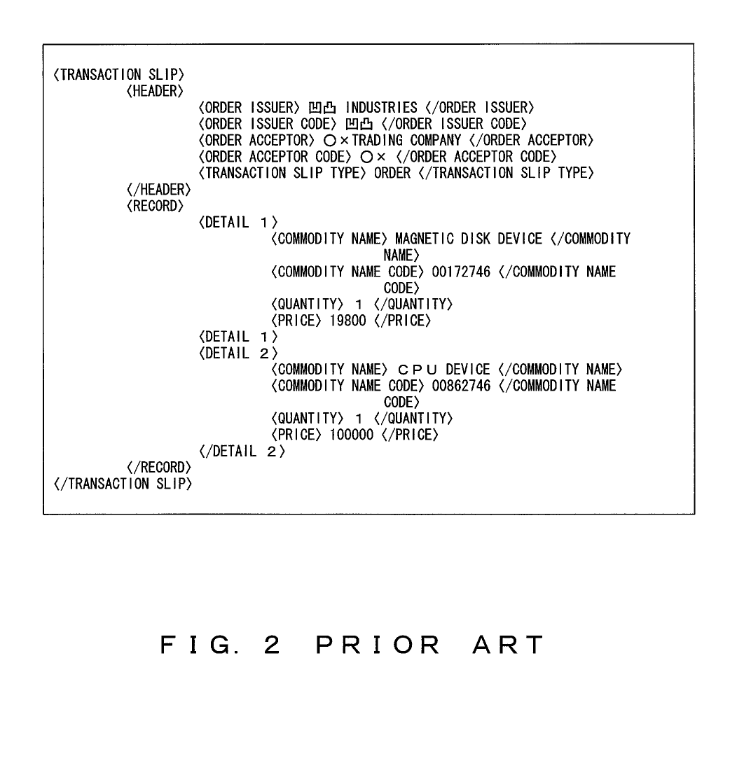

FIG. 3 is a block diagram showing the basic structure of an embodiment of the present invention;

FIG. 4 is a flow chart showing a transaction slip data storing process of a database managing module;

FIG. 5 is a flow chart showing a content data extracting process of the database managing module;

FIG. 6 is a schematic diagram showing management data and content data stored in a database device;

FIG. 7 is a block diagram showing the structure of the system according to the embodiment of the present invention;

FIG. 8 is a schematic diagram showing the structure of the system according to the embodiment of the present invention in the case that there are a plurality of order issuers, a plurality of order acceptor server devices, and a plurality of order acceptors;

FIG. 9 is a schematic diagram for explaining a transaction slip data format converting process (No. 1);

FIG. 10 is a schematic diagram for explaining the transaction slip data format converting process (No. 2);

FIG. 11 is a flow chart for explaining the transaction slip data format converting process (No. 3);

FIG. 12 is a schematic diagram for explaining a content data transferring process (No. 1);

FIG. 13 is a flow chart for explaining the content data transferring process (No. 2);

FIG. 14 is a block diagram showing the structure of the system in the case that each section of a company R has an order acceptor browser and settles transaction slip data (No. 1);

FIG. 15 is a schematic diagram for explaining a process of the system shown in FIG. 14 (No. 2); and

FIG. 16 is a block diagram showing an example of a hardware environment necessary for accomplishing a function of an order issuer server device or an order acceptor server device with a program.

### DESCRIPTION OF PREFERRED EMBODIMENT

When an electronic data exchanging process is performed in inter-company electronic commerce, transaction slip data is searched for particular element data as a search object. Thus, when transaction slip data is stored, element data as a search object is pre-stored to a management data area. As a result, when required transaction slip data is extracted in the electronic data exchanging process, the searching process is performed for only data stored in the management data area rather than all the transaction slip data. Thus, the searching process can be performed at high speed.

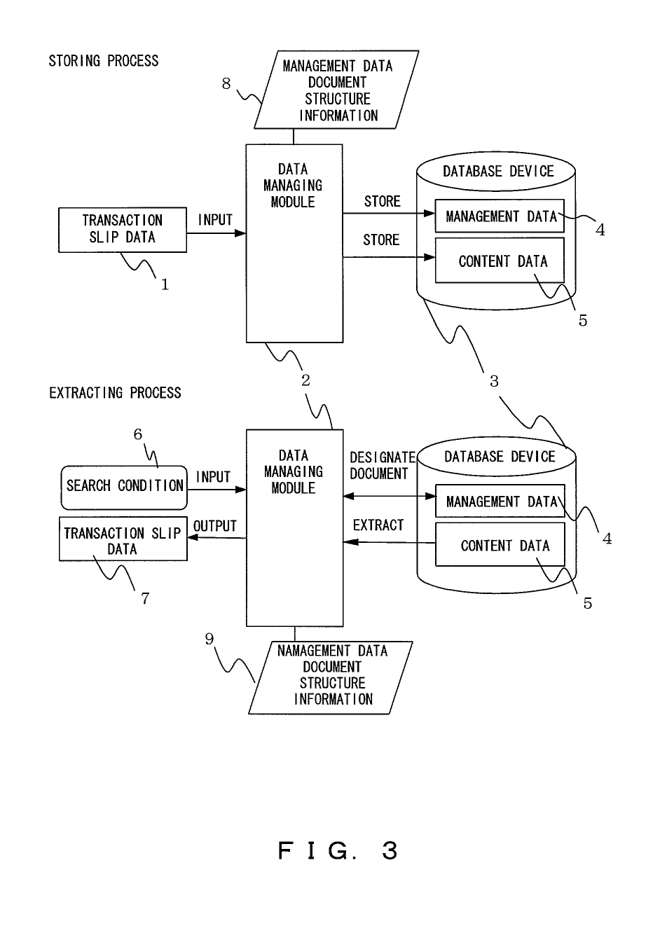

FIG. 3 is a block diagram showing the basic structure of the embodiment of the present invention.

The embodiment of the present invention comprises a database device 3 and a data managing module 2. The database device 3 contains table elements of XML document names and XML document data. The data managing module 2 executes a data storing process and a data extracting process for the database device 3.

According to the embodiment of the present invention, XML documents stored in the database device 3 can be categorized as two types. The first type is content data (XML document) used in the inter-company electronic commerce. The second type is management data (XML document) of which information (for example, order issuer information, order acceptor information, and transaction slip data type) that is frequently referenced from the content data in the electronic data exchanging process of the inter-company electronic commerce. Hereinafter, the first type and the second type are referred to as content data 5 and management data 4, respectively.

The data managing module 2 has an API (Application Program Interface) used for the storing process. With the API for the storing process, transaction slip data 1 is input and stored. In addition, the data managing module 2 has another API used for the extracting process. With the API for the extracting process, a search condition 6 as a data element of transaction slip data 7 is input and transaction slip data 7 that matches the search condition 6 is output.

As an initial setting of the data managing module 2, an XML document structure including a group of data elements frequently referenced in the electronic data exchanging process should be pre-registered. The registered information is stored as management data document structure information 8 and 9 to the data managing module 2. A data element designated as a search condition by the input API for the extracting process should be contained in the group of data elements registered as the management data document structure.

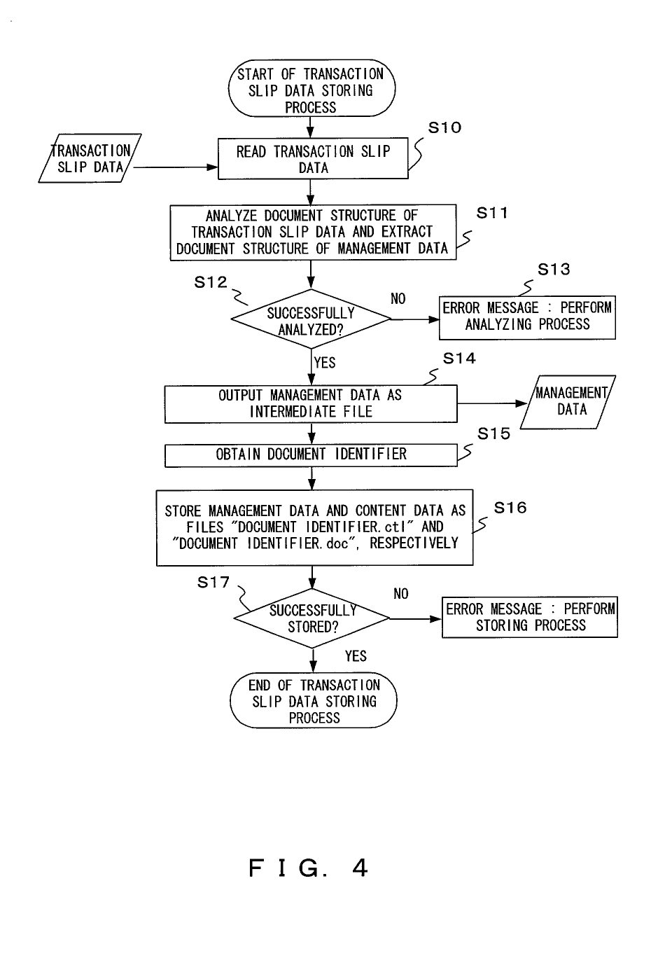

FIG. 4 is a flow chart showing a transaction slip data storing process of the database managing module.

At step S10, content data is read. At step S11, the document structure of the content data is analyzed. Corresponding to the analyzed result, management data and the document structure thereof are extracted. At step S12, it is determined whether or not the document structure has been successfully analyzed. When the determined result at step S12 is No (namely, the document structure has not been successfully analyzed), the flow advances to step S13. At step S13, an error message or the like that represents an error of the analyzing process is presented to the user and then the process is completed. When the determined result at step S12 is Yes (namely, the document structure has been successfully analyzed), the flow advances to step S14. At step S14, the management data is output as an intermediate file (temporary file). At step S15, a document identifier for identifying the content data that has been read at step S10 is obtained. Thereafter, the flow advances to step S16. At step S16, the management data and the content data are stored as a file “document identifier.ctl” and a file “document identifier.doc”, respectively, to the database device 3. At step S17, it is determined whether or not the management data and the content data have been successfully stored to the database device 3. When the determined result at step S17 is No (namely, the management data and the content data have not been successfully stored to the database device 3), an error message or the like is presented to the user so as to prompt him or her for a retry. When the determined result at step S17 is Yes (namely, the management data and the content data have been successfully stored to the database device 3), the process is completed.

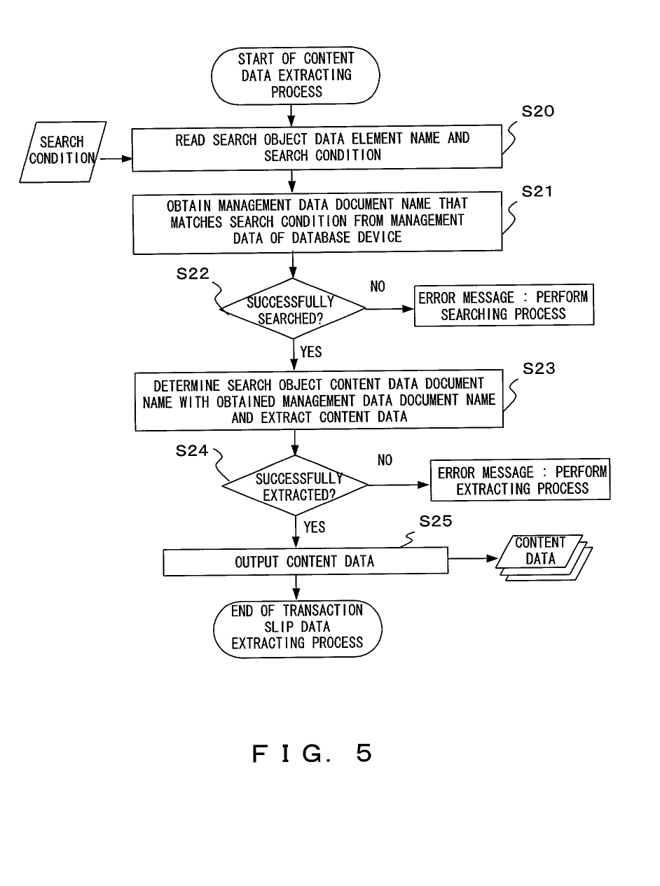

FIG. 5 is a flow chart showing a transaction slip data extracting process of the database managing module.

In the extracting process, at step S20, a search object data element and a search condition are read from the input search condition. A management data document name that matches the search condition is obtained from the management data 4 stored in the database device (at step S21). At step S22, it is determined whether or not a management data document name has been successfully obtained. When the determined result at step S22 is No (namely, a management data document name has not been successfully obtained), an error message or the like is presented to the user and the process is completed. On the other hand, when the determined result at step S22 is Yes (namely, a management data document name has been successfully obtained), the flow advances to step S23. At step S23, a content data document name as a search object is determined with the obtained management data document name and then the content data is extracted therefrom. In other words, the obtained management data document name has been assigned a document identifier in the storing process. In addition, since a unique document identifier is assigned to each content data in each database device, the content data 5 having assigned an obtained document identifier as a document name is content data 5 that matches the input search condition, the content data 5 having assigned the obtained document identifier is extracted from the database device 3. At step S24, it is determined whether or not content data has been successfully extracted. When the determined result at step S24 is No (namely, content data has not been successfully extracted), an error process is performed. In contrast, when the determined result at step S24 is Yes (namely, content data has been successfully extracted), the flow advances to step S25. At step S25, the extracted content data is output and then the process is completed.

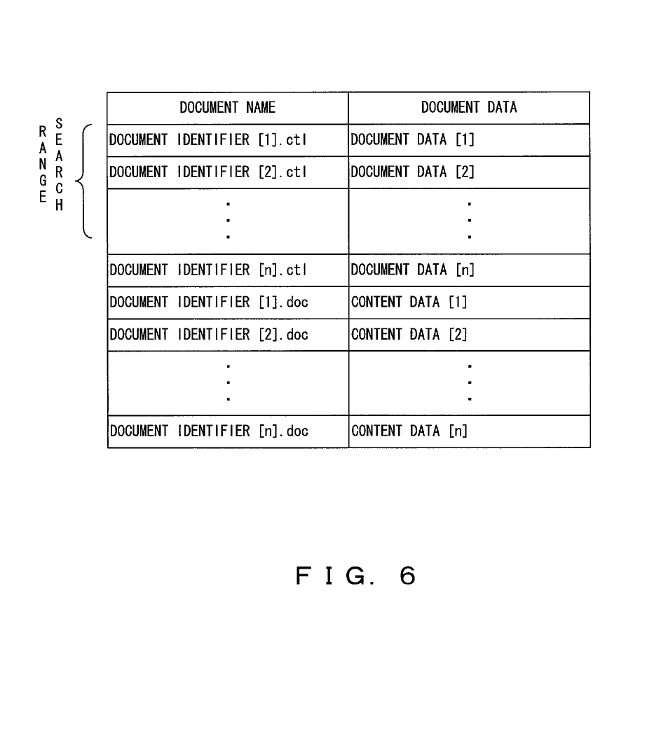

FIG. 6 is a schematic diagram showing management data and content data stored in a database device.

As shown in FIGS. 4 and 5, when transaction slip data is stored to a database device, if the transaction slip data is divided into management data 4 and content data 5 and separately stored to the database device, the database device can be searched for only the management data 4 that matches a search condition as shown in FIG. 6.

In other words, it is not necessary to search all transaction slip data. Thus, the searching process can be performed at high speed. Even if a large amount of transaction slip data is stored in the data managing module 2 of an order issuer server or an order acceptor server, transaction slip data necessary for the electronic data exchanging process can be effectively searched.

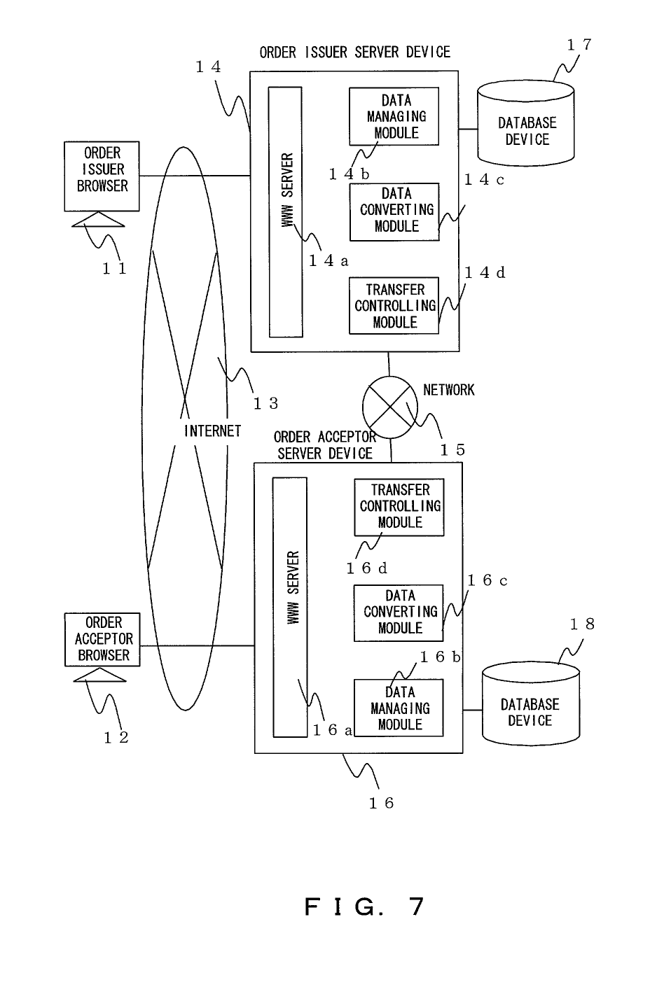

FIG. 7 is a block diagram showing the structure of the system according to the embodiment of the present invention.

The system shown in FIG. 7 comprises an order issuer browser 11, an order acceptor browser 12, an order issuer server device 14, a database device 17, an order acceptor server device 16, a database device 18, Internet 13, and a network 15. The database device 17 is connected to the order issuer server device 14. The database device 18 is connected to the order acceptor server device 16. The Internet 13 is a network that connects the order issuer browser 11 and the order issuer server device 14 and that connects the order acceptor browser 12 and the order acceptor server device 16. The network 15 connects the order issuer server device 14 and the order acceptor server device 16.

The order issuer server device 14 comprises a WWW server 14a, a data managing module 14b, a conversion controlling module 14c, and a transfer controlling module 14d. The order acceptor server device 16 comprises a WWW server 16a, a data managing module 16b, a conversion controlling module 16c, and a transfer controlling module 16d that are the same as those of the order acceptor server device.

Next, an order issuing process and an order receiving process of the system shown in FIG. 7 will be described. In the order issuing process, an order is issued and transmitted by the order issuer browser 11. In the order receiving process, an order is received and accepted by the order acceptor browser 12.

The WWW server 14a of the order issuer server device 14 receives an XML document of order slip data from the order issuer browser 11. The data managing module 14b stores the XML document of the order slip data as an XML document of management data and an XML document of content data to the database device 17. In the case, the data managing module 14b is a module having the function of the data managing module 2 shown in FIG. 3. The data managing module 14b stores the order slip data to the database device 17 corresponding to the storing process shown in FIG. 4.

When the format of transaction slip data such as estimate slip data and order slip data of an order issuer is different from that of an order acceptor, the data managing module 14b extracts relevant transaction slip data from the database device 17 and converts it corresponding to a predetermined converting process of the order issuer server device 14 and the order acceptor server device 16. In the converting process, for example, the fields of order information of transaction slip data are changed. Alternatively, the currency unit and various codes of the transaction slip data of an order issuer are changed to those of an order acceptor. In the case, the data managing module 14b is a module having the function of the data managing module 2 shown in FIG. 3. The data managing module 14b extracts transaction slip data from the database device 17 corresponding to the extracting process shown in FIG. 5.

The data managing module 14b extracts order slip data to be transferred to the order acceptor server device 16 through the network 15 from data of a plurality of order slips accepted by the order issuer server device 14 and stored in the database device 17 under the control of the transfer controlling module 14d and transfers the extracted order slip data corresponding to a predetermined communicating process of the order issuer server device 14 and the order acceptor server device 16. In that case, the data managing module 14b is a module having the function of the data managing module 2. The data managing module 14b extracts order slip data from the database device 17 corresponding to the extracting process shown in FIG. 5.

The transfer controlling module 16d of the order acceptor server device 16 receives transaction slip data from the order issuer server device 14. The data managing module 16b stores the transaction slip data as an XML document of management data and an XML document of content data to the database device 18. In that case, the data managing module 16b is a module having the function of the data managing module 2 shown in FIG. 3. The data managing module 16b stores the transaction slip data to the database device 18 corresponding to the storing process shown in FIG. 4.

Finally, the data managing module 16b of the order acceptor server device 16 extracts transaction slip data that matches the condition transmitted from the order acceptor browser 12 from the database device 18 and transmits the extracted transaction slip data to the order acceptor browser 12. In that case, the data managing module 16b is a module having the function of the data managing module 2 shown in FIG. 3. The data managing module 16b extracts the transaction slip data from the database device 18 corresponding to the extracting process shown in FIG. 5.

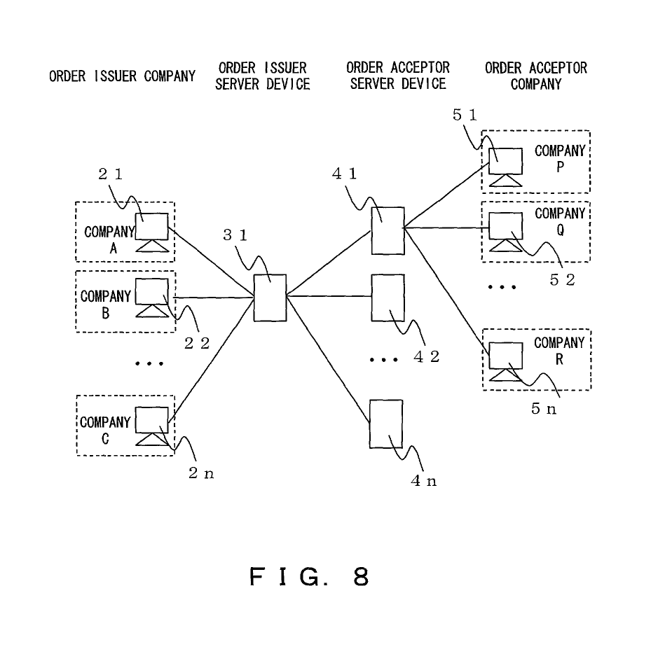

FIG. 8 is a block diagram showing the structure of the system according to the embodiment of the present invention in the case that there are a plurality of order issuers, a plurality of order issuer servers, and a plurality of order acceptors.

In other words, referring to FIG. 8, there a plurality of companies (companies A, B, and C) that have order issuer browsers each, a plurality of order accepter server devices (41 to 4n) connected to an order issuer server device 31 through a network, and a plurality of companies (companies P, Q, and R) that have order acceptor browsers each connected to one of the order acceptor server devices.

Referring to FIG. 8, a database device connected to the order issuer server device 31 contains data of a plurality of transaction slips to be transferred to the order acceptor servers 41 to 4n. Desired data of a transaction slip can be extracted from data of the plurality of transaction slips. The embodiment of the present invention is applied to such a system. Moreover, in the structure shown in FIG. 8, a database device connected to the order acceptor server device 41 stores data of a plurality of transaction slips that is transmitted to order acceptor browsers 51 to 5n. Data of desired transaction slip is extracted from data of the plurality of transaction slips. The embodiment of the present invention is applied to such a system.

Referring to FIG. 8, only one order issuer server device 31 is shown. However, in reality, a plurality of order issuer server devices 31 may be connected to the plurality of order acceptor server devices 41 to 4n. A plurality of order acceptor browsers 51 to 5n of the order acceptor companies P to R may be connected to the plurality of order acceptor server devices 41 to 4n, respectively.

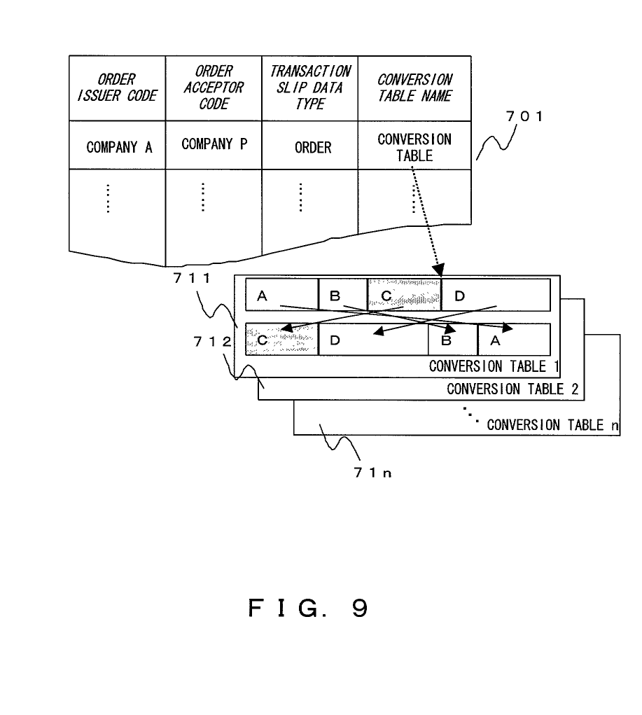

FIGS. 9, 10, and 11 are schematic diagrams for explaining a transaction slip data format converting process.

There may be a situation of which the formats of transaction slips such as an estimate slip and an order slip of an order issuer are different from those of an order acceptor. In such a situation, after transaction slip data is extracted, the data should be converted corresponding to the differences of the formats. In that case, the conversion controlling module 14c shown in FIG. 7 executes the converting process for the extracted transaction slip data. On the other hand, when an order acceptor browser transmits transaction slip data to an order issuer browser, the conversion controlling module 16c executes the converting process for the transaction slip data.

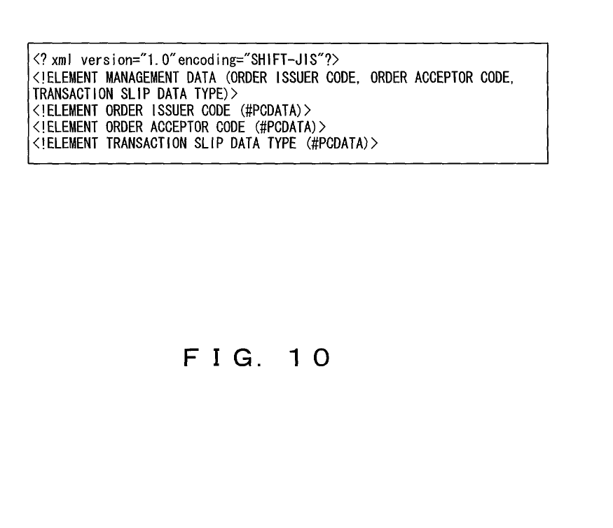

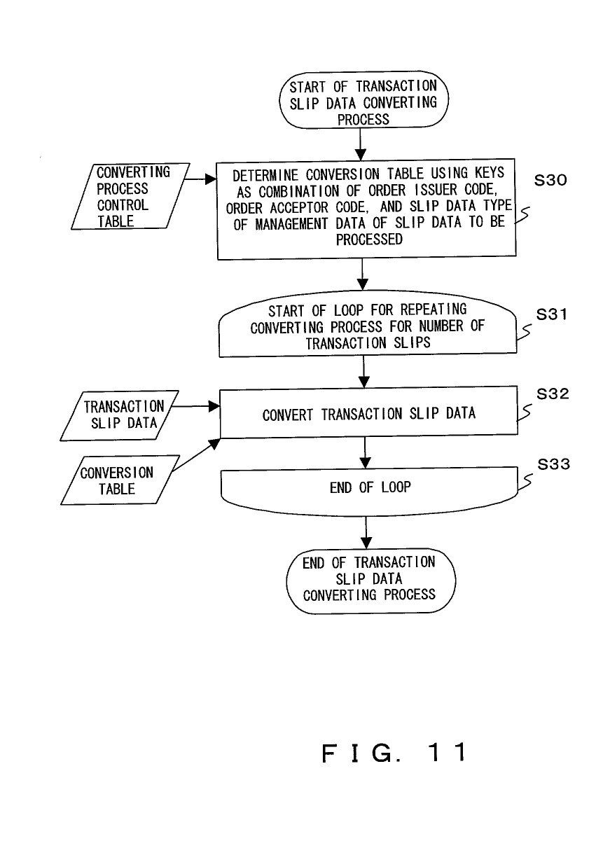

In the case that conversion tables 711 to 71n that contain transaction slip data format converting rules between transaction slip data of order issuers and transaction slip data of order acceptors and a conversion process controlling table 701 that correlates the conversion tables 711 to 71n and combinations of an order issuer code that identifies an order issuer in transaction slip data, an order acceptor code that identifiers an order acceptor therein, a transaction slip data type that identifies the type of transaction slip data such as an estimate slip or an order slip are used in the system shown in FIG. 8, when a system that defines management data document structure information shown in FIG. 10 is used, the content of the converting process can be determined and executed with keys of the order acceptor code, the order issuer code, and the transaction slip data type as shown in FIG. 11. In FIG. 10, the system uses a format described in DTD (Document Type Definitions) of the XML as the management data document structure information. In FIG. 10, the management data includes an order issuer code, an order acceptor code, and a transaction slip data type as management items.

FIG. 11 is a flow chart for explaining the transaction slip data format converting process.

Referring to FIG. 11, at step S30, a conversion table using keys as a combination of an order issuer code, an order acceptor code, and a transaction slip data type of the management data of transaction slip data to be processed is determined. A loop from step S31 to step S33 is repeated for the number of slips to be converted. In other words, at step S32, corresponding to the conversion table, the transaction slip data is converted. At step S33, it is determined whether or not data of all the slips has been converted. When data of all the slips has been converted, the converting process is completed.

In the structure of the system shown in FIG. 8, transaction slip data that is transmitted from the company A to the company P is transferred from the order issuer server device 31 to the order acceptor server device 41. When the extracted transaction slip data is transferred, the transfer controlling module 16d shown in FIG. 7 executes the transferring process for the extracted transaction slip data. On the other hand, when an order acceptor browser transmits transaction slip data to an order issuer browser, the transfer controlling module 16d executes the transferring process of the extracted transaction slip data. In the transferring process, the order acceptor server device 41 should change a transfer destination corresponding to an order acceptor coder that identifies an order acceptor in the transaction slip data.

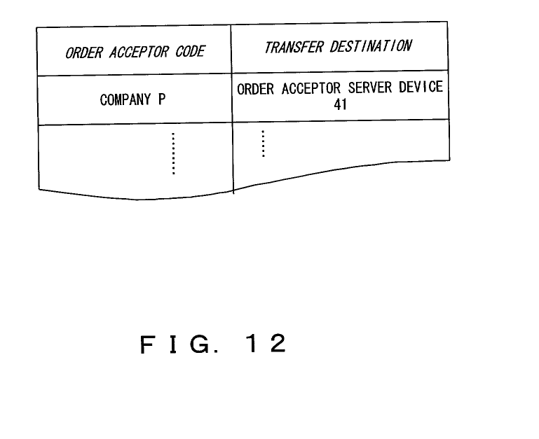

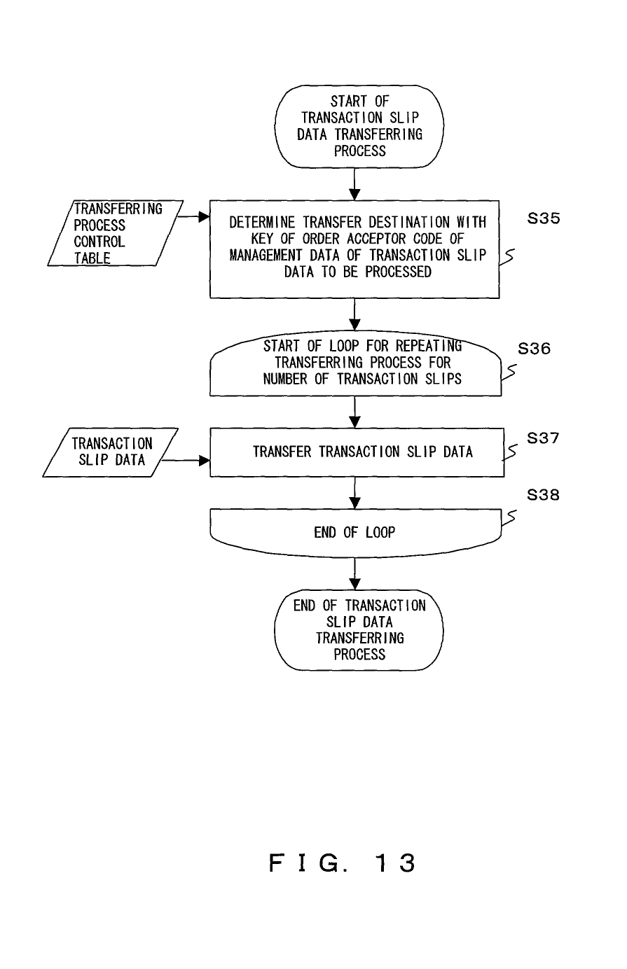

FIGS. 12 and 13 are schematic diagram for explaining a transaction slip data transferring process.

FIG. 12 shows a route control table that defines an order acceptor code representing an order acceptor of transaction slip data and a transfer destination. When a system that defines the management data document structure information shown in FIG. 10 is used corresponding to the route control table, the content of the transferring process can be determined with a key of the order acceptor code of the management data shown in FIG. 13. As a result, the transaction slip data transferring process can be executed.

In other words, referring to FIG. 13, at step S35, with a key of a acceptor code of management data of transaction slip data to be processed, a transfer destination is determined corresponding to the route control table as shown in FIG. 12. In a loop from S36 to S38, the transferring process is repeated for the number of transaction slips. In other words, at step S37, transaction slip data is transferred. At step S38, it is determined whether or not all transaction slip data has been transferred. When all the transaction slip has been transferred, the process is completed.

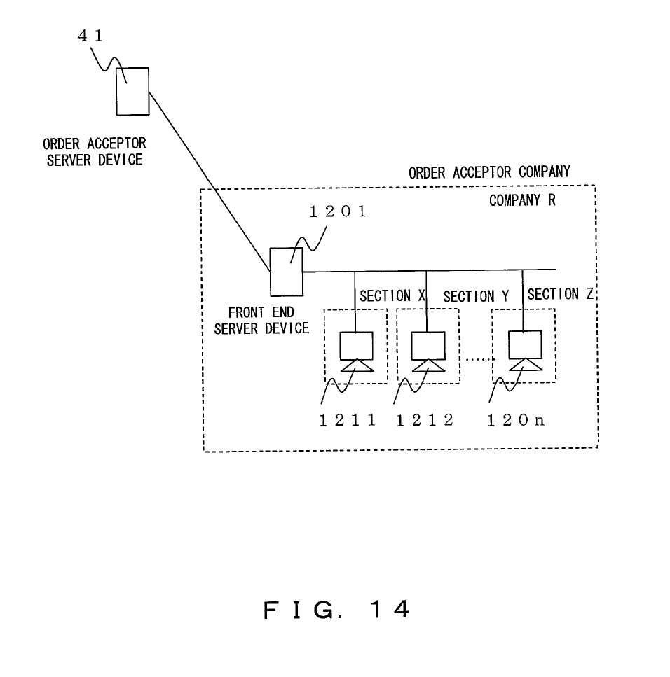

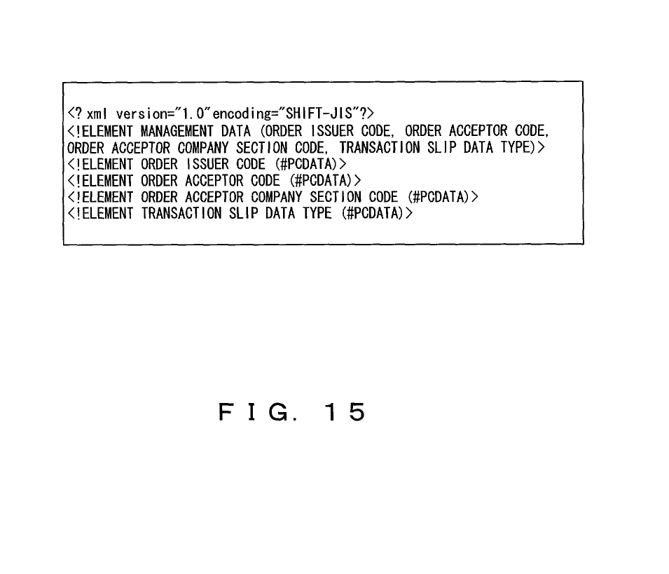

FIG. 14 is a block diagram showing the structure of the system in the case that each section of the company R in the system shown in FIG. 8 has an order acceptor browser and each section settles transaction slip data. FIG. 15 is a schematic diagram for explaining the process performed in the system shown in FIG. 14.

When each section of a company settles transaction slip data, each section should search transaction slip data with a key of a code that identifies each section. In the structure shown in FIG. 14, transaction slip data for sections X, Y, and Z should be extracted. Thus, in the system shown in FIG. 14, a front end server device 1201 that has the same function as an order acceptor server or an order issuer server is connected to the order acceptor server device 41 and order acceptor browsers of sections X, Y, and Z. Management data document structure information containing a section code shown in FIG. 15 is defined as management data document structure information of the front end server device 1201. In FIG. 15, as the management data, besides an order issuer code, an order acceptor code, and a slip data type, an order acceptor company section code is registered.

In the transaction slip data storing process of the front end server device 1201, since management data containing the section code is stored, transaction slip data can be searched with a section code as a search condition.

When the XML is used, the definition of information of management data can be easily changed. Thus, when a company section code is required as management data, the company section code is extracted from transaction slip data as document data described in the XML corresponding to a tag of the XML and can be easily stored as management data. Thus, the supervisor of the system can dynamically change the content of management data. As a result, the supervisor can manage transaction slip data corresponding to a request of the user of the system according to the embodiment of the present invention.

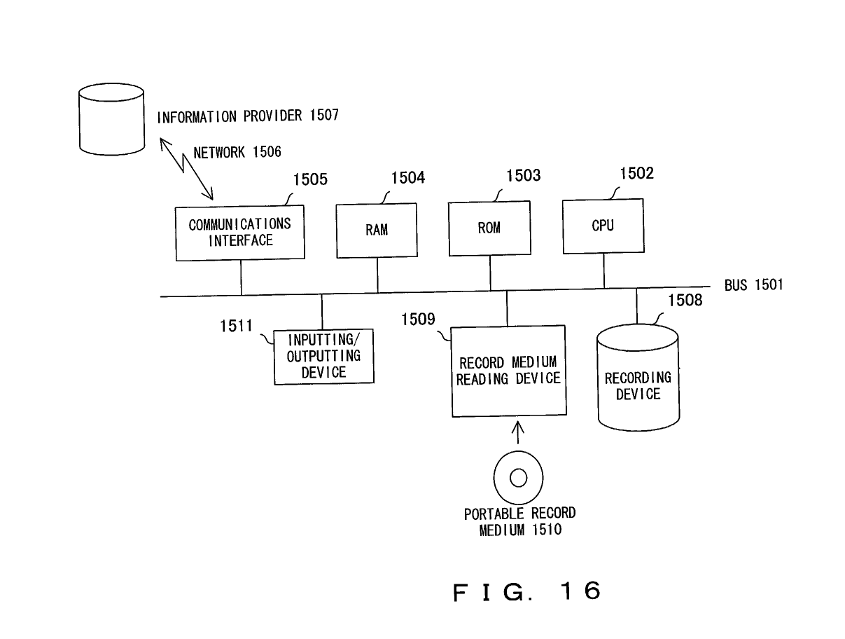

FIG. 16 is a block diagram showing an example of a hardware environment necessary for accomplishing the function of an order issuer server device or an order acceptor server device with a program.

A CPU 1502 is connected to a ROM 1503, a RAM 1504, a communication interface 1505, a recording device 1508, a record medium reading device 1509, and an inputting/outputting device 1511. Management data, transaction slip data, conversion table, transfer destination table, and so forth are stored to the recording device 1508 such as a hard disk or a portable record medium 1510 such as a CD-ROM, a DVD, or a floppy disk. Data recorded on the portable record medium 1510 is read by the CPU 1502 through the record medium reading device 1509.

When the CPU 1502 performs an storing process, an extracting process, or a transferring process, a program that accomplishes such a process is read from the recording device 1508 or the portable record medium 1510 and stored to the RAM 1504. As a result, the CPU 1502 can execute the program. Alternatively, the program may be stored in a ROM 1503 so that the CPU 1502 can directly execute the program.

In addition, the ROM 1503 stores a basic program such as BIOS. When the system gets started, the basic program is executed so that the user can input a command from the inputting/outputting device 1511 and a processed result is presented to the user. The inputting/outputting device 1511 is composed of a display, a mouse, a keyboard, and so forth.

The communication interface 1505 accesses an information provider 1507 through a network 1506. The communication interface 1505 allows programs necessary for the CPU 1502 for the storing process, the extracting process, and the transferring process to be downloaded so that the CPU 1502 can execute the programs. When the network 1506 is an LAN or the like, the programs can be executed in the network environment. Alternatively, the database that contains management data and content data may be a database of an information provider connected to the network 1506. In that case, when it is necessary to process content data and management data, the CPU 1502 causes the communication interface 1505 to access the database of an information provider 1507 through the network 1506 so as to download and process required data.

According to the present invention, a document structure of data elements to be searched is extracted from a document structure of transaction slip data. Management data and content data are stored as different documents. The management data and the content data are linked with a document identifier. Since only management data is searched, the searching process can be effectively performed. In addition, since the structure of management data can be dynamically changed corresponding to the content of the electronic data exchanging process, a document managing function corresponding to the structure of the system can be provided.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. A managing apparatus for managing a transaction slip data document used in electronic commerce with a database device, comprising:
a data extracting unit extracting data as a search item of the transaction slip data document therefrom;
a storing unit storing the data extracted by said data extracting means as management data in correlation with the transaction slip data;
a transaction slip data extracting unit searching the management data so as to extract correlated transaction slip data; and
a transmitting unit transmitting the transaction slip data extracted by said transaction slip data extracting unit.

2. The managing apparatus as set forth in claim 1,
wherein the correlation between the management data and the transaction slip data is managed with a document identifier that is common therebetween.

3. The managing apparatus as set forth in claim 1, further comprising:
a receiving unit receiving the transmitted transaction slip data; and
a converting unit converting the format of the received transaction slip data into a format with which a transmission destination can deal.

4. The managing apparatus as set forth in claim 1,
wherein the designation of a search item as the management data is dynamically changeable.

5. The managing apparatus as set forth in claim 4,
wherein the transaction slip data document is an XML document, and
wherein a search item is dynamically changed by changing the designation of an extraction of an item corresponding to a tag of the XML document.

6. A record medium for storing a program that causes a computer as an information apparatus to manage a transaction slip data document used in electronic commerce with a database device, the program comprising:
(a) extracting data as a search item of the transaction slip data document therefrom;
(b) storing the data extracted at step (a) as management data in correlation with the transaction slip data;
(c) searching the management data so as to extract correlated transaction slip data; and
(d) transmitting the transaction slip data extracted at step (c).
